(19) United States
(12) Patent Application Publication
(10) Pub. No.: US 2014/0183408 A1
(43) Pub. Date: Jul. 3, 2014

(54) Mixture for Liquid Crystal Medium and Liquid Crystal Display Using the Same

(71) Applicant: Shenzhen China Star Optoelectronics Technology Co. Ltd., Shenzhen, Guangdong (CN)

(72) Inventors: Xing Feng, Shenzhen (CN); Xinhui Zhong, Shenzhen (CN)

(73) Assignee: Shenzhen China Star Optoelectronics Technology Co., Ltd., Shenzhen, Guangdong (CN)

(21) Appl. No.: 13/703,624

(22) PCT Filed: Oct. 16, 2012
(86) PCT No.: PCT/CN2012/083022

§ 371 Date: Dec. 11, 2012

(30) Foreign Application Priority Data
Sep. 21, 2012 (CN) 201210360717.8

(51) Int. Cl. C09K 19/56

(52) U.S. Cl. CPC C09K 19/56
USPC 252/299.61; 252/299.01; 252/299.63; 252/299.66

(57) ABSTRACT

The present invention provides a mixture for liquid crystal medium and a liquid crystal display using the same. The mixture for liquid crystal medium comprises: a liquid crystal material, a polymerizable monomer and a sensitizer. The sensitizer has strong absorbability within the wavelength range of 300-360 nm of the ultraviolet light. The liquid crystal display comprising: an upper substrate and a lower substrate which are parallel with each other, and a mixture for liquid crystal medium provided between the upper substrate and the lower substrate. The sensitizer according to the present invention has strong absorbability within the wavelength range of 300-360 nm of the ultraviolet light, which allows the response wavelength of the polymerizable monomer shifting to longer wavelength. Using ultraviolet light irradiation within the wavelength range of 300-360 nm avoids the absorption band of the liquid crystal material, which reduces the damaging effects of ultraviolet light on liquid crystal material and alignment material of polyimide (PI), and improves the efficiency of the polymerization reaction and uniformity of the polymerizable monomer.

This application claims priority to Chinese Patent Application Serial No. 201210360717.8, named as “mixture for liquid crystal medium and liquid crystal display using the same”, filed on Sep. 21, 2012, the specification of which is incorporated herein by reference.

### BACKGROUND OF THE INVENTION

1. Field of the Invention

The present invention relates to the field of liquid crystal display technology, and in particular to a mixture for liquid crystal medium and a liquid crystal display using the same.

2. The Related Arts

In LCD industry, polymer stabilized vertical alignment (PSVA) technology developed in recent years, compared with conventional twisted nematic/super twisted nematic (TN/STN) technology, has several advantages of wide viewing angle, high contrast, and fast response. Relative to other VA technology, such as multi-domain vertical alignment (MVA) and patterned vertical alignment (PVA), also have considerable advantages in transmission and the simplicity of the process. Therefore, PSVA has become a mainstream technology in thin film transistor liquid crystal display (TFT-LCD) industry nowadays.

In critical process of PSVA, it uses negative type liquid crystal. When no voltage is applied, the long axis of the liquid crystal molecules is perpendicular to the surface of the substrate. A certain amount of polymerizable monomers, which will polymerize under UV irradiation, are added in the liquid crystal material, which is abbreviated to RM. After the liquid crystal is dropped on the substrate and assembled, suitable frequency, waveform, and voltage signal are applied to the panel, which allows the liquid crystal molecules inclining along a predetermined direction. At the same time, the panel is irradiated by an ultraviolet light, so that the RM will polymerize to form a polymer and be deposited on the surface of the two substrates within the panel, which is called polymer bump. The liquid crystal molecules will produce a certain pre-inclined angle without applied voltage, which increases the response speed of the liquid crystal molecules. Relative rubbing can only produce single alignment direction, while this method can produce multi-angle alignment in different regions (pre-inclined angle) within the panel.

According to U.S. Pat. No. 7,169,449, it discloses that photoreactive group contained in reactive Mesogen (RM) used in the art of PSVA is usually selected from the group consisting of methacrylate group, acrylate group, vinyl group, ethylene group or epoxy group, especially methacrylate group. But directly using ultraviolet light irradiation reaction causes several problems within these RM reactions: the main wavelength range, which allows the RM mentioned above occurring photopolymerization reaction, is within 200-300 nm. Although the ultraviolet light of the wavelength exceeding 300 nm also allows the RM occurring photopolymerization reaction, the efficiency is very low, the speed is very slow, and it does not have good mass production. Therefore, the light of the wavelength less than 300 nm is used to irradiate the panel and allows RM to react. However, the use of the light source less than 300 nm will bring the production of the panel many disadvantages and difficulty. Firstly, the ultraviolet light less than 300 nm has higher energy, which will decompose the alignment layer material, polyimide, and the liquid crystal molecules, and then the voltage holding ratio (VHR) is reduced, image sticking becomes worse, the reliability analysis (RA) becomes worse, and so on. Secondly, the glass used to produce the substrate of the TFT-LCD usually has certain absorption of the ultraviolet light less than 300 nm, which decreases the radiation efficiency of the light source. Furthermore, the liquid crystal material has strong absorption of the ultraviolet light less than 300 nm, the ultraviolet light of wavelength less than 300 nm cannot pass through the liquid crystal material, that is, most of ultraviolet light from a light source is absorbed by the liquid crystal material (causing damaging effects). Only a few of that is absorbed by RM and occurring the polymerization. This takes place at a very shallow position of light entering side, leading to the unevenness of RM reaction occurred at the light entering side and the backlight side, which reduces the panel alignment effect.

### SUMMARY OF THE INVENTION

The technical issue to be solved by the present invention is to provide a mixture for liquid crystal medium, which comprises a sensitizer having strong absorbability within the wavelength range of 300-360 nm of the ultraviolet light. The sensitizer allows the response wavelength of the polymerizable monomer shifting to longer wavelength, which improves the efficiency of the polymerization reaction and uniformity of the polymerizable monomer.

The present invention further provides a liquid crystal display comprising the mixture for liquid crystal medium mentioned above, which avoids the absorption band of the liquid crystal material by using ultraviolet light irradiation within the wavelength range of 300-360 nm, which reduces the damaging effects of ultraviolet light on liquid crystal material and alignment material of polyimide (PI), improves the efficiency of the polymerization reaction and uniformity of the polymerizable monomer, improves the panel alignment effects, and then increases the quality and the life time of the panel.

In order to solve the technical issue, the embodiment according to the present invention provides a mixture for liquid crystal medium comprising: a liquid crystal material, a polymerizable monomer and a sensitizer, the structural formula of the sensitizer defined as follows:

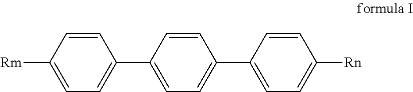

wherein, Rm and Rn independently represent the alkyl containing number of carbon atoms from 1 to 12.

Wherein, the polymerizable monomer of the mixture for liquid crystal medium will polymerize under UV irradiation within the wavelength of 300-360 nm through the sensitizer.

Wherein, the alkenyl compound is defined by the following structural formulas:

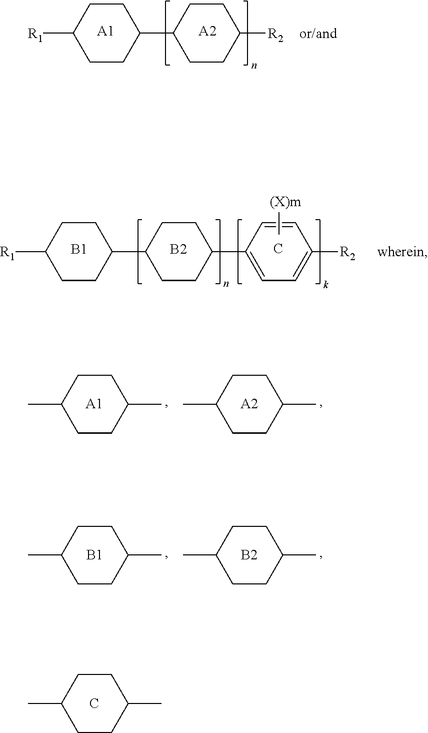

independently represents:

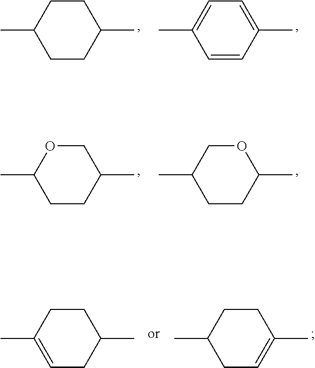

R1 represents the straight chain or branched chain alkenyl containing number of carbon atoms from 2 to 9;
R2 represents the straight chain or branched chain alkyl containing number of carbon atoms from 1 to 12;
X independently represents H, F, Cl, OCF₃ or CF₃;
m represents from 1 to 4;
n and k respectively represents from 0 to 3.

Wherein, the polymerizable monomer comprises at least one polymerizable molecule, which is defined by the following structural formula:

P₁-L₁-X-L₂-P₂

wherein, in the formula, P₁ and P₂ represent polymerizable groups, and each them are the same or different, which are selected from the group consisting of methacrylate group, acrylate group, vinyl group, ethylene group or epoxy group, and all the polymerizable groups in the formula are not methacrylate group simultaneously; L₁ and L₂ represent linking groups, and each them are the same or different, which are selected from the group consisting of carbon-carbon single bond, —O—, —COO—, —OCO—, —CH₂O—, —OCH₂O—, —O(CH₂)₂O—, —COCH₂— or methylene; X represents a core group, which is

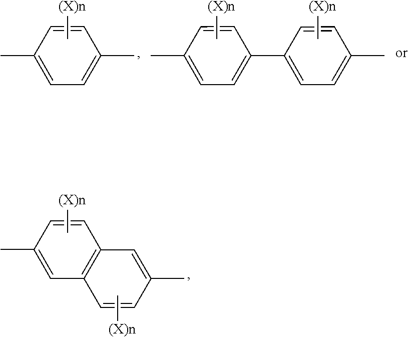

wherein, x represents the substituent group connected to the ring structure, n is an integer of 1-4, the multiple n in any molecular formula are the same or different, if n>1, it represents that there are multiple substituent groups x in the same ring structure, each them are the same or different, the substituent group x is selected from the group consisting of —H, —F, —Cl, —Br, —I, —CN or —NO₂.

Wherein, in the mixture for liquid crystal medium, the weight ratio of the sensitizer to the polymerizable monomer is 0.01% to 10%.

Correspondingly, another embodiment according to the present invention further provides a liquid crystal display comprising: a upper substrate and a lower substrate which are parallel with each other, and a mixture for liquid crystal medium provided between the upper substrate and the lower substrate, the mixture for liquid crystal medium comprising: a liquid crystal material, a polymerizable monomer and a sensitizer, the structural formula of the sensitizer defined as follows:

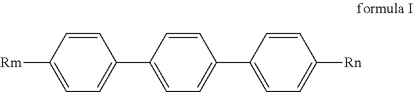

wherein, Rm and Rn independently represent the alkyl containing number of carbon atoms from 1 to 12.

Wherein, the polymerizable monomer of the mixture for liquid crystal medium will polymerize under UV irradiation within the wavelength of 300-380 nm through the sensitizer.

Wherein, the alkenyl compound is defined by the following structural formulas:

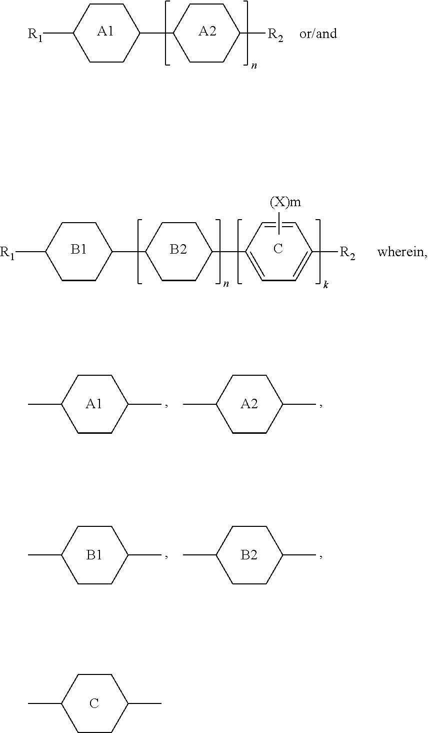

independently represents:

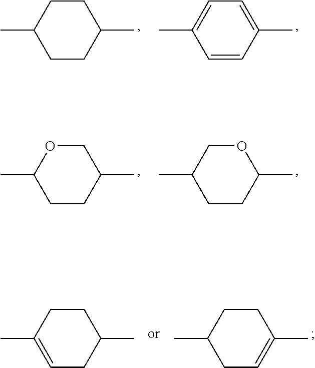

R1 represents the straight chain or branched chain alkenyl containing number of carbon atoms from 2 to 9;
R2 represents the straight chain or branched chain alkyl containing number of carbon atoms from 1 to 12;
X independently represents H, F, Cl, OCF₃ or CF₃;
m represents from 1 to 4;
n and k respectively represents from 0 to 3.

Wherein, the polymerizable monomer comprises at least one polymerizable molecule, which is defined by the following structural formula:

P₁-L₁-X-L₂-P₂

wherein, in the formula, P₁ and P₂ represent polymerizable groups, and each them are the same or different, which are selected from the group consisting of methacrylate group, acrylate group, vinyl group, ethylene group or epoxy group, and all the polymerizable groups in the formula are not methacrylate group simultaneously; L₁ and L₂ represent linking groups, and each them are the same or different, which are selected from the group consisting of carbon-carbon single bond, —O—, —COO—, —OCO—, —CH₂O—, —OCH₂O—, —O(CH₂)₂O—, —COCH₂— or methylene; X represents a core group, which is

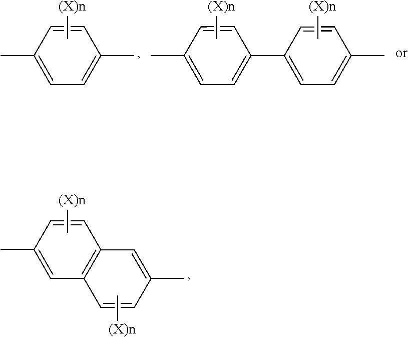

wherein, x represents the substituent group connected to the ring structure, n is an integer of 1-4, the multiple n in any molecular formula are the same or different, if n>1, it represents that there are multiple substituent groups x in the same ring structure, each them are the same or different, the substituent group x is selected from the group consisting of —H, —F, —Cl, —Br, —I, —CN or —NO₂.

Wherein, in the mixture for liquid crystal medium, the weight ratio of the sensitizer to the polymerizable monomer is 0.01% to 10%.

The embodiment according to the present invention has the beneficial effects as follow.

The mixture for liquid crystal medium according to the present invention is added with terphenyl as a sensitizer. The sensitizers may interact with the alkenyl compound in the polymerizable monomer to form exciplex. The absorbed energy can be transferred to the polymerizable monomer to initiate the polymerization reaction, which allows the response wavelength of the polymerizable monomer shifting to longer wavelength (300-360 nm), which improves the efficiency of the polymerization reaction and uniformity of the polymerizable monomer.

The liquid crystal display using the mixture for liquid crystal medium avoids the absorption band of the liquid crystal material by using ultraviolet light irradiation within the wavelength range of 300-360 nm, which reduces the damaging effects of ultraviolet light on liquid crystal material and alignment material of polyimide (PI), improves the efficiency of the polymerization reaction and uniformity of the polymerizable monomer, improves the panel alignment effects, increases the quality and the life time of the panel, and stabilizes the mass production. The obtained liquid crystal display has high reliability.

### DETAILED DESCRIPTION OF THE PREFERRED EMBODIMENTS

In order to further illustrate technical means and effects thereof according to the present invention, the accompanying drawings and the following detailed descriptions are the preferred embodiments of the present invention.

The mixture for liquid crystal medium according to the present invention comprises: a liquid crystal material, a polymerizable monomer and a sensitizer. The sensitizer have strong absorbability within the wavelength range of 300-360 nm of the ultraviolet light. The sensitizers may interact with the polymerizable monomer to form exciplex. The absorbed energy can be transferred to the polymerizable monomer to initiate the polymerization reaction. The structural formula of the sensitizer is defined as follows:

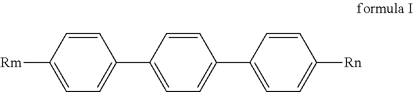

wherein, Rm and Rn independently represent the alkyl containing number of carbon atoms from 1 to 12.

Said sensitizers have similar characteristics in the chemical structure, which have larger π conjugated system. In general, the larger conjugated system is within a certain range, the longer absorption wavelength is. The added amount of the sensitizer accounts for 5 ppm-1000 ppm of total mixture for liquid crystal medium.

The alkenyl compound is defined by the following structural formulas:

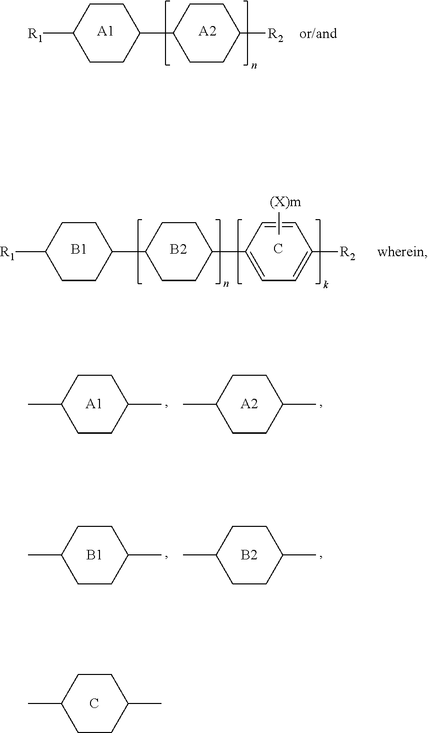

independently represents:

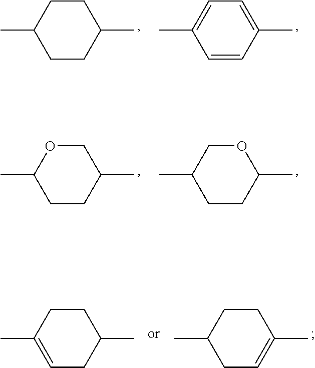

R1 represents the straight chain or branched chain alkenyl containing number of carbon atoms from 2 to 9;
R2 represents the straight chain or branched chain alkyl containing number of carbon atoms from 1 to 12;
X independently represents H, F, Cl, OCF₃ or CF₃;
m represents from 1 to 4;
n and k respectively represents from 0 to 3.

The polymerizable monomer comprises at least one polymerizable molecule, which is defined by the following structural formula:

P₁-L₁-X-L₂-P₂

wherein, in the formula, P₁ and P₂ represent polymerizable groups, and each them are the same or different, which are selected from the group consisting of methacrylate group, acrylate group, vinyl group, ethylene group or epoxy group, and all the polymerizable groups in the formula are not methacrylate group simultaneously; L₁ and L₂ represent linking groups, and each them are the same or different, which are selected from the group consisting of carbon-carbon single bond, —O—, —COO—, —OCO—, —CH₂O—, —OCH₂O—, —O(CH₂)₂O—, —COCH₂— or methylene; X represents a core group, which is

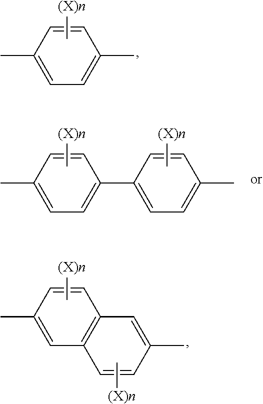

wherein, x represents the substituent group connected to the ring structure, n is an integer of 1-4, the multiple n in any molecular formula are the same or different, if n>1, it represents that there are multiple substituent groups x in the same ring structure, each them are the same or different, the substituent group x is selected from the group consisting of —H, —F, —Cl, —Br, —I, —CN or —NO₂.

The polymerizable monomer of the mixture for liquid crystal medium according to the present invention will polymerize under UV irradiation within the wavelength of 300-360 nm through the sensitizer. That is, when using ultraviolet light irradiation to occur the polymerization reaction, the ultraviolet light of the wavelength within 300-360 nm can be used. In that band, few or no ultraviolet light will be absorbed by the liquid crystal material, which reduces the damaging effects of the liquid crystal material. The sensitizer has strong absorption to the ultraviolet light band, which will interact with the polymerizable monomer to form exciplex. The absorbed energy can be transferred to the polymerizable monomer to initiate the polymerization reaction, which allows the response wavelength of the polymerizable monomer shifting to longer wavelength (the reaction wavelength shifts from 200-300 nm to 300-360 nm). The sensitizer itself does not undergo any chemical reaction, which only plays the role of energy transfer, so that there are no adverse effects on the mixture for liquid crystal medium and the produced liquid crystal display.

The mixture for liquid crystal medium according to the present invention can be applied in display. The liquid crystal display according to the present invention uses the mixture for liquid crystal medium mentioned above, which comprises a upper substrate and a lower substrate which are parallel with each other, and a mixture for liquid crystal medium provided between the upper substrate and the lower substrate. The mixture for liquid crystal medium is the mixture for liquid crystal medium according to the present invention mentioned above and not be repeated here.

The mixture for liquid crystal medium comprises the sensitizer which has strong absorbability within the wavelength range of 300-380 nm of the ultraviolet light. By using the ultraviolet light (wavelength 300-380 nm) irradiation to the mixture for liquid crystal medium, the sensitizer absorbs the energy in the band and transfers to the polymerizable monomer to occur the polymerization reaction. The efficiency of the polymerization reaction and uniformity of the polymerizable monomer are good. The formed polymer is uniform. It improves the panel alignment effects, increases the quality and the life time of the panel, and stabilizes the mass production. The obtained liquid crystal display has high reliability.

The preferred embodiment according to the present invention is described as follows.

### Embodiment 1

Prepare upper and lower substrates. There are a data line, a gate line, a TFT array, an ITO pixel electrode and a common electrode on the lower substrate. The substrate surface is coated with an alignment layer. There are a black matrix and R, G, and B pixels on the upper substrate. There are a support and a common electrode between the substrates. The upper substrate is also coated with an alignment layer. Using a negative-type liquid crystal material, and mixing with the polymerizable monomer and the sensitizer to form the mixture for liquid crystal medium. Wherein, the structural formula of the sensitizer is as follows:

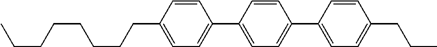 [SMILES: CCCCCCCCc1ccc(-c2ccc(-c3ccc(CCC)cc3)cc2)cc1]

The added amount of the sensitizer in the mixture for liquid crystal medium is 70 ppm, the weight ratio of which to the polymerizable monomer is 0.01% to 10%. After assembling the upper and lower substrates and the liquid crystal medium to form a panel, uses the ultraviolet light of wavelength within 310-360 nm irradiating from the upper substrate to the panel, which allows the polymerizable monomer occurring the polymerization reaction to form the polymer and completes the alignment.

In summary, the mixture for liquid crystal medium according to the present invention, by using a sensitizer which allows the response wavelength of the polymerizable monomer shifting from 200-300 nm to 300-360 nm, which avoids the absorption band of the liquid crystal material and improves the efficiency of the polymerization reaction and uniformity of the polymerizable monomer. The liquid crystal display using the mixture for liquid crystal medium, by using the ultraviolet light of wavelength within 300-360 nm, avoids the absorption band of the liquid crystal material, which reduces the damaging effects of ultraviolet light on liquid crystal material and alignment material of polyimide (PI), improves the quality and the life time of the panel, and stabilizes the mass production. The obtained liquid crystal display has high reliability.

It is to be understood that many other possible modifications and variations can be made by those skilled in the art without departing from the spirit and scope of the invention as hereinafter claimed, and those modifications and variations are considered encompassed in the scope of protection defined by the clams of the present invention.

What is claimed is:

1. A mixture for liquid crystal medium comprising: a liquid crystal material, a polymerizable monomer and a sensitizer, the liquid crystal material comprising an alkenyl compound which is stable to the polymerization reaction during the polymerization of the polymerizable monomer, the structural formula of the sensitizer defined as follows: 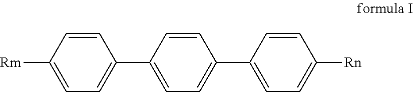
wherein, Rm and Rn independently represent the alkyl containing number of carbon atoms from 1 to 12.

2. The mixture for liquid crystal medium as claimed in claim 1, characterized in that the polymerizable monomer of the mixture for liquid crystal medium will polymerize under UV irradiation within the wavelength of 300-360 nm through the sensitizer.

3. The mixture for liquid crystal medium as claimed in claim 1, characterized in that the alkenyl compound is defined by the following structural formulas: 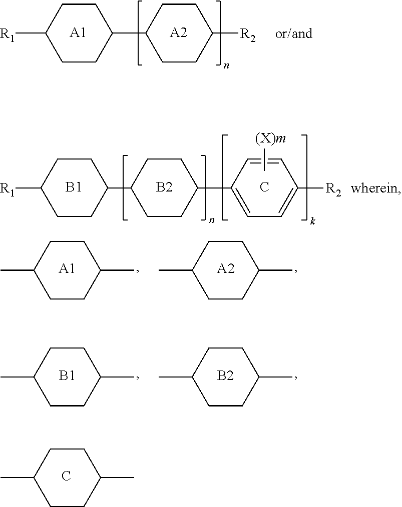
independently represents: 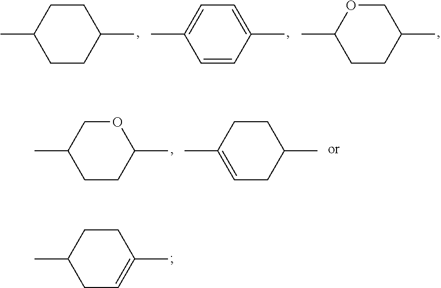
R1 represents the straight chain or branched chain alkenyl containing number of carbon atoms from 2 to 9;
R2 represents the straight chain or branched chain alkyl containing number of carbon atoms from 1 to 12;
X independently represents H, F, Cl, OCF₃ or CF₃;
m represents from 1 to 4;
n and k respectively represents from 0 to 3.

4. The mixture for liquid crystal medium as claimed in claim 3, characterized in that in the mixture for liquid crystal medium, the weight ratio of the sensitizer to the polymerizable monomer is 0.01% to 10%.

5. The mixture for liquid crystal medium as claimed in claim 1, characterized in that the polymerizable monomer comprises at least one polymerizable molecule, which is defined by the following structural formula:
P₁-L₁-X-L₂-P₂
wherein, in the formula, P₁ and P₂ represent polymerizable groups, and each them are the same or different, which are selected from the group consisting of methacrylate group, acrylate group, vinyl group, ethylene group or epoxy group, and all the polymerizable groups in the formula are not methacrylate group simultaneously; L₁ and L₂ represent linking groups, and each them are the same or different, which are selected from the group consisting of carbon-carbon single bond, —O—, —COO—, —OCO—, —CH₂O—, —OCH₂O—, —O(CH₂)₂O—, —COCH₂— or methylene; X represents a core group, which is 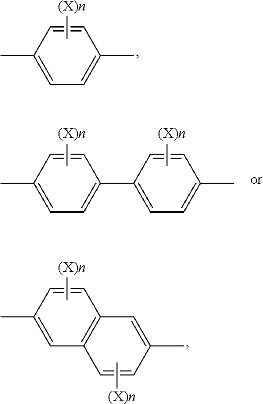
wherein, x represents the substituent group connected to the ring structure, n is an integer of 1-4, the multiple n in any molecular formula are the same or different, if n>1, it represents that there are multiple substituent groups x in the same ring structure, each them are the same or different, the substituent group x is selected from the group consisting of —H, —F, —Cl, —Br, —I, —CN or —NO₂.

6. The mixture for liquid crystal medium as claimed in claim 2, characterized in that the polymerizable monomer comprises at least one polymerizable molecule, which is defined by the following structural formula:
P₁-L₁-X-L₂-P₂
wherein, in the formula, P₁ and P₂ represent polymerizable groups, and each them are the same or different, which are selected from the group consisting of methacrylate group, acrylate group, vinyl group, ethylene group or epoxy group, and all the polymerizable groups in the formula are not methacrylate group simultaneously; L₁ and L₂ represent linking groups, and each them are the same or different, which are selected from the group consisting of carbon-carbon single bond, —O—, —COO—, —OCO—, —CH₂O—, —OCH₂O—, —O(CH₂)₂O—, —COCH₂— or methylene; X represents a core group, which is 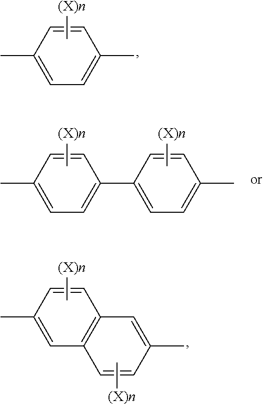
wherein, x represents the substituent group connected to the ring structure, n is an integer of 1-4, the multiple n in any molecular formula are the same or different, if n>1, it represents that there are multiple substituent groups x in the same ring structure, each them are the same or different, the substituent group x is selected from the group consisting of —H, —F, —Cl, —Br, —I, —CN or —NO₂.

7. The mixture for liquid crystal medium as claimed in claim 3, characterized in that the polymerizable monomer comprises at least one polymerizable molecule, which is defined by the following structural formula:
P₁-L₁-X-L₂-P₂
wherein, in the formula, P₁ and P₂ represent polymerizable groups, and each them are the same or different, which are selected from the group consisting of methacrylate group, acrylate group, vinyl group, ethylene group or epoxy group, and all the polymerizable groups in the formula are not methacrylate group simultaneously; L₁ and L₂ represent linking groups, and each them are the same or different, which are selected from the group consisting of carbon-carbon single bond, —O—, —COO—, —OCO—, —CH₂O—, —OCH₂O—, —O(CH₂)₂O—, —COCH₂— or methylene; X represents a core group, which is 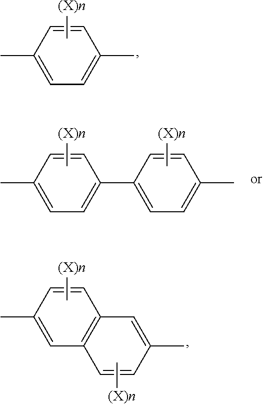
wherein, x represents the substituent group connected to the ring structure, n is an integer of 1-4, the multiple n in any molecular formula are the same or different, if n>1, it represents that there are multiple substituent groups x in the same ring structure, each them are the same or different, the substituent group x is selected from the group consisting of —H, —F, —Cl, —Br, —I, —CN or —NO₂.

8. The mixture for liquid crystal medium as claimed in claim 4, characterized in that the polymerizable monomer comprises at least one polymerizable molecule, which is defined by the following structural formula:
P₁-L₁-X-L₂-P₂
wherein, in the formula, P₁ and P₂ represent polymerizable groups, and each them are the same or different, which are selected from the group consisting of methacrylate group, acrylate group, vinyl group, ethylene group or epoxy group, and all the polymerizable groups in the formula are not methacrylate group simultaneously; L₁ and L₂ represent linking groups, and each them are the same or different, which are selected from the group consisting of carbon-carbon single bond, —O—, —COO—, —OCO—, —CH₂O—, —OCH₂O—, —O(CH₂)₂O—, —COCH₂— or methylene; X represents a core group, which is 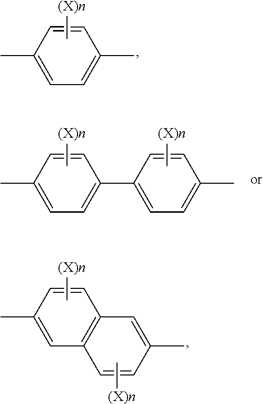
wherein, x represents the substituent group connected to the ring structure, n is an integer of 1-4, the multiple n in any molecular formula are the same or different, if n>1, it represents that there are multiple substituent groups x in the same ring structure, each them are the same or different, the substituent group x is selected from the group consisting of —H, —F, —Cl, —Br, —I, —CN or —NO₂.

9. A liquid crystal display comprising: a upper substrate and a lower substrate which are parallel with each other, and a mixture for liquid crystal medium provided between the upper substrate and the lower substrate, the mixture for liquid crystal medium comprising: a liquid crystal material, a polymerizable monomer and a sensitizer, the liquid crystal material comprising an alkenyl compound which is stable to the polymerization reaction during the polymerization of the polymerizable monomer, the structural formula of the sensitizer defined as follows: 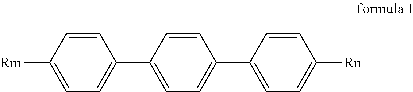
wherein, Rm and Rn independently represent the alkyl containing number of carbon atoms from 1 to 12.

10. The liquid crystal display as claimed in claim 9, characterized in that the polymerizable monomer of the mixture for liquid crystal medium will polymerize under UV irradiation within the wavelength of 300-380 nm through the sensitizer.

11. The liquid crystal display as claimed in claim 10, characterized in that the alkenyl compound is defined by the following structural formulas: 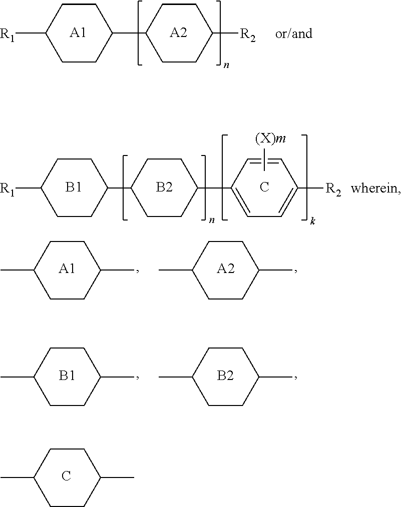
independently represents: 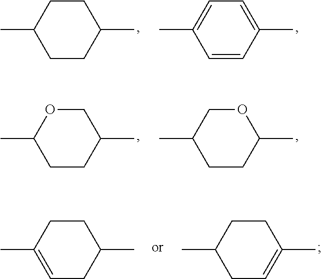
R1 represents the straight chain or branched chain alkenyl containing number of carbon atoms from 2 to 9;
R2 represents the straight chain or branched chain alkyl containing number of carbon atoms from 1 to 12;
X independently represents H, F, Cl, OCF₃ or CF₃;
m represents from 1 to 4;
n and k respectively represents from 0 to 3.

12. The liquid crystal display as claimed in claim 11, characterized in that in the mixture for liquid crystal medium, the weight ratio of the sensitizer to the polymerizable monomer is 0.01% to 10%.

13. The liquid crystal display as claimed in claim 9, characterized in that the polymerizable monomer comprises at least one polymerizable molecule, which is defined by the following structural formula:
P₁-L₁-X-L₂-P₂
wherein, in the formula, P₁ and P₂ represent polymerizable groups, and each them are the same or different, which are selected from the group consisting of methacrylate group, acrylate group, vinyl group, ethylene group or epoxy group, and all the polymerizable groups in the formula are not methacrylate group simultaneously; L₁ and L₂ represent linking groups, and each them are the same or different, which are selected from the group consisting of carbon-carbon single bond, —O—, —COO—, —OCO—, —CH₂O—, —OCH₂O—, —O(CH₂)₂O—, —COCH₂— or methylene; X represents a core group, which is 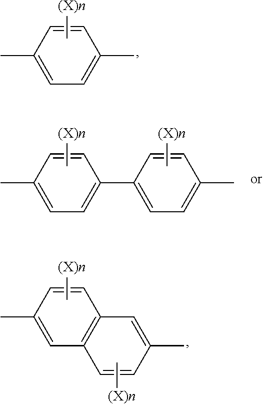
wherein, x represents the substituent group connected to the ring structure, n is an integer of 1-4, the multiple n in any molecular formula are the same or different, if n>1, it represents that there are multiple substituent groups x in the same ring structure, each them are the same or different, the substituent group x is selected from the group consisting of —H, —F, —Cl, —Br, —I, —CN or —NO₂.

14. The liquid crystal display as claimed in claim 10, characterized in that the polymerizable monomer comprises at least one polymerizable molecule, which is defined by the following structural formula:
P₁-L₁-X-L₂-P₂
wherein, in the formula, P₁ and P₂ represent polymerizable groups, and each them are the same or different, which are selected from the group consisting of methacrylate group, acrylate group, vinyl group, ethylene group or epoxy group, and all the polymerizable groups in the formula are not methacrylate group simultaneously; L₁ and L₂ represent linking groups, and each them are the same or different, which are selected from the group consisting of carbon-carbon single bond, —O—, —COO—, —OCO—, —CH₂O—, —OCH₂O—, —O(CH₂)₂O—, —COCH₂— or methylene; X represents a core group, which is 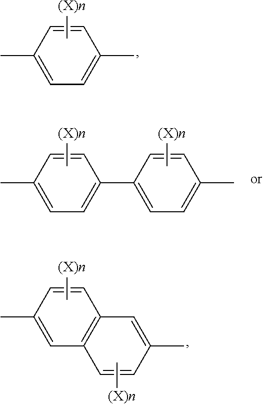
wherein, x represents the substituent group connected to the ring structure, n is an integer of 1-4, the multiple n in any molecular formula are the same or different, if n>1, it represents that there are multiple substituent groups x in the same ring structure, each them are the same or different, the substituent group x is selected from the group consisting of —H, —F, —Cl, —Br, —I, —CN or —NO₂.

15. The liquid crystal display as claimed in claim 11, characterized in that the polymerizable monomer comprises at least one polymerizable molecule, which is defined by the following structural formula:
P₁-L₁-X-L₂-P₂
wherein, in the formula, P₁ and P₂ represent polymerizable groups, and each them are the same or different, which are selected from the group consisting of methacrylate group, acrylate group, vinyl group, ethylene group or epoxy group, and all the polymerizable groups in the formula are not methacrylate group simultaneously; L₁ and L₂ represent linking groups, and each them are the same or different, which are selected from the group consisting of carbon-carbon single bond, —O—, —COO—, —OCO—, —CH₂O—, —OCH₂O—, —O(CH₂)₂O—, —COCH₂— or methylene; X represents a core group, which is 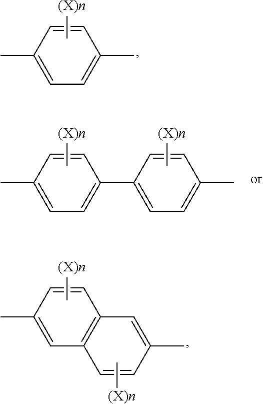
wherein, x represents the substituent group connected to the ring structure, n is an integer of 1-4, the multiple n in any molecular formula are the same or different, if n>1, it represents that there are multiple substituent groups x in the same ring structure, each them are the same or different, the substituent group x is selected from the group consisting of —H, —F, —Cl, —Br, —I, —CN or —NO₂.

16. The liquid crystal display as claimed in claim 12, characterized in that the polymerizable monomer comprises at least one polymerizable molecule, which is defined by the following structural formula:
P₁-L₁-X-L₂-P₂
wherein, in the formula, P₁ and P₂ represent polymerizable groups, and each them are the same or different, which are selected from the group consisting of methacrylate group, acrylate group, vinyl group, ethylene group or epoxy group, and all the polymerizable groups in the formula are not methacrylate group simultaneously; L₁ and L₂ represent linking groups, and each them are the same or different, which are selected from the group consisting of carbon-carbon single bond, —O—, —COO—, —OCO—, —CH₂O—, —OCH₂O—, —O(CH₂)₂O—, —COCH₂— or methylene; X represents a core group, which is 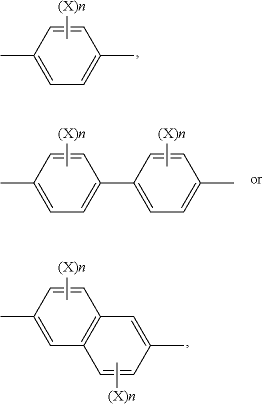
wherein, x represents the substituent group connected to the ring structure, n is an integer of 1-4, the multiple n in any molecular formula are the same or different, if n>1, it represents that there are multiple substituent groups x in the same ring structure, each them are the same or different, the substituent group x is selected from the group consisting of —H, —F, —Cl, —Br, —I, —CN or —NO₂.
